(19) United States
(12) Patent Application Publication
(10) Pub. No.: US 2009/0265255 A1
(43) Pub. Date: Oct. 22, 2009

(54) Systems, Devices, and Methods for Supporting Decisions

(76) Inventors: John Clarke Jackson, Laurel, MD (US); Brian Eugene Cunningham, Laurel, MD (US); Travis Ames Hurant, Washington, DC (US)

Correspondence Address: MICHAEL N. HAYNES, 1341 HUNTERSFIELD CLOSE, KESWICK, VA, 22947, US

(21) Appl. No.: 12/103,143

(22) Filed: Apr. 15, 2008

Related U.S. Application Data
(60) Provisional application No. 60/914,044, filed on Apr. 26, 2007.
(60) Provisional application No. 60/927,039, filed on May 1, 2007.

(51) Int. Cl. G06F 17/30

(52) U.S. Cl. 705/27

(57) ABSTRACT

Certain exemplary embodiments can provide a method that can include: sending software to a first information device and to a second information device, the software adapted to cause display of information regarding user-selected items; receiving an identifier of a selected item; and providing the identifier to the software on the second information device.

### CROSS-REFERENCE TO RELATED APPLICATIONS

This application claims priority to, and incorporates by reference herein in its entirety, pending U.S. Provisional Patent Application 60/914,044 (Attorney Docket No. 1108-003), filed 26 Apr. 2007, and pending U.S. Provisional Patent Application 60/927,039 (Attorney Docket No. 1108-004), filed 1 May 2007.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is an exemplary illustration of an exemplary User Interface;

FIG. 2 is an exemplary illustration of a sample Selection Criteria Component;

FIG. 3 is an exemplary illustration of a sample Catalog View of a Product Display Component;

FIG. 4 is an exemplary illustration of a sample Catalog View of a Product Display Component;

FIG. 5 is an exemplary illustration of a sample List View of a Product Display Component;

FIG. 6 is an exemplary illustration of a sample Presentation View of a Product Display Component;

FIG. 7 is an exemplary illustration of a user dragging a product to Favorites;

FIG. 8 is an exemplary illustration of products marked as favorites with a heart icon in an exemplary Product Display Component;

FIG. 9 is an exemplary illustration of the Generate Brochure button used to create a custom brochure from the Favorites Component;

FIG. 10 is an exemplary illustration of products marked as having Personal Product Notes with a note icon in an exemplary Product Display Component;

FIG. 11 is an exemplary illustration of products with Personal Product Ratings displayed with star icons in an exemplary Product Display Component;

FIG. 12 is an exemplary illustration of two online users shopping together from different locations;

FIG. 13 is an exemplary illustration of an exemplary Shop Together Invitation Component that uses email to send the session-specific link to the invited user;

FIG. 14 is an exemplary illustration of a sample Shop Together User Component synchronized between two users in Independent Exploration Mode;

FIG. 15 is an exemplary illustration of a sample Multi-User Favorites/History Component synchronized between two users;

FIG. 16 is an exemplary illustration of a sample Shop Together User Component and a sample Multi-User Favorites/History Component;

FIG. 17 is an exemplary illustration of a sample Shop Together User Component synchronized between multiple users in Synchronized Exploration Mode;

FIG. 18 is an exemplary illustration of a sample Shop Together User Component synchronized between multiple users in Synchronized Exploration Mode;

FIG. 19 is an exemplary illustration of a sample Shop Together User Component synchronized between multiple users in Synchronized Exploration Mode;

FIG. 20 is an exemplary illustration of a sample Shop Together User Component synchronized between multiple users in Synchronized Exploration Mode;

FIG. 21 is an exemplary illustration of a sample Shop Together User Component and a sample Multi-User Favorites/History Component;

FIG. 22 is an exemplary illustration of a sample Shop Together User Component synchronized between two users in Independent Exploration Mode;

FIG. 23 is an exemplary illustration of a sample Shop Together Product-Based Chat Component between two users in Independent Exploration Mode;

FIG. 24 is a block diagram of an exemplary embodiment of a system;

FIG. 25 is a block diagram of an exemplary embodiment of a system and Shop Together process;

FIG. 26 is a block diagram of an exemplary embodiment of a system and Activity Tracking process;

FIG. 27 is a block diagram of an exemplary embodiment of a system and State Preservation process;

FIG. 28 is a block diagram of an exemplary embodiment of a system;

FIG. 29 is a block diagram of an exemplary embodiment of an information device; and

FIG. 30 is a flowchart of an exemplary embodiment of a method.

### DETAILED DESCRIPTION

Traditional shopping can be a very social experience. There might be multiple decision makers (e.g., a couple buying furniture, a car, a cruise) who will research, compare options, and/or make a decision together. In other cases, there might be one decision maker who wants input from a friend and/or family member (e.g., a mother helping her son buy a car, one friend helping another pick out a digital camera, a daughter helping her father choose a prescription drug plan). Additionally, a shopper might look to a customer service representative, sales person, broker, agent, and/or other expert for assistance in making a decision (e.g., a real estate agent helping a home buyer, a professional decorator helping a couple looking to remodel their home, a car sales person helping an auto buyer, a mortgage broker helping a loan applicant). These types of social shopping activities do not tend to be facilitated well by traditional methods of online shopping. This can create resistance and/or a barrier to purchase in cases where more than one person would normally be involved in making and/or influencing the purchase decision, which can lead to increasing user frustration and/or abandonment rates.

Within the traditional online environment, using highly interactive technology (i.e., and/or e.g., Rich Internet applications utilizing and/or developed using, for example, Asynchronous JavaScript and XML (AJAX), Adobe Flash, Adobe Flex, and/or other similar technology) to provide the user interface, in which a substantial level of processing is performed by the client rather than the server, and/or a substantial level of functionality is provided in the browser and/or user interface rather than on the server, can make it difficult to track user behavior within the application, because much of the interaction typically occurs in the browser, client, and/or user interface, and does not necessarily require a call back to the server for each action as tends to be the case in traditional HTML applications. In the traditional HTML scenario, each page refresh typically can be tracked. With highly interactive technology, the user can use the application for a long time with no call back to the server and hence no tracking of user behavior. This can provide a significant barrier to understanding customers and/or learning from their behavior.

Using highly interactive technology can create an additional challenge. If the user refreshes the web page (for example by pressing the Back button and/or closing the browser and returning later), the application will typically reload and start again from the beginning with any user changes or settings lost. This can create a poor user experience that can increase user frustration and/or abandonment rates.

Certain exemplary embodiments, sometimes referred to herein as “Shop Together™”, can make use of a messaging server (similar to that found in Adobe Flex 2) or other such mechanism to connect multiple instances of an online product exploration application in a way that can control which components are synchronized between users (and/or which are left to function independently for each user) and/or control the relationship between synchronized and non-synchronized components. This method of synchronization can be controlled at a user level by subscription to different session and/or sub-session threads combined with different modes of component synchronization. The result can allow the implementation of solutions such as:
a. Independent Exploration Mode in Shop Together;
b. Synchronized Exploration Mode in Shop Together;
c. Product-Based Chat Component;
d. Shared Favorites/History Component in Shop Together; and/or
e. One-Time Component Synchronization in Shop Together.

Certain exemplary embodiments can provide methods of creating the components and/or connecting them through the messaging server (using an event and/or state level broadcast and/or subscription interface) that can allow the saving and/or setting of the events and/or states for a given component by methods other than the messaging server. These can include cookies, server-side sessions, log files, databases, and/or any other method for storing and retrieving this type of information. The result can be that the system can save and/or later reload the state of the components (and/or the entire application). This can allow the implementation of solutions such as: Component State Preservation for highly interactive technology.

By saving the event and/or state information as described above in, for example, server-side log files and/or databases, the user behavior-tracking problem described above can be overcome. By reloading the logged events from a single user session into another instance of an application in chronological order, the system can replay the actions of that user session and/or see what the original user did during there session. This can provide additional insights into user behavior. The result can allow the implementation of solutions such as:
a. Session Activity Tracking for highly interactive technology; and/or
b. Replaying Session Activity for highly interactive technology.

Certain exemplary embodiments can allow users to explore products (i.e., one or more goods and/or services) independently while seeing what the other users are looking at. Certain exemplary embodiments can allow the system to synchronize individual components on the page instead of synchronizing the whole page, allowing much greater flexibility in creating a powerful interactive shopping experience. Certain exemplary embodiments can directly synchronize a component so that every user action is synchronized or can just synchronize information about a component while still allowing independent interaction with the component (for example a user could click on an item in favorites to see more information without having that click broadcast to all users, but if they added an item to favorites that addition could be sent to all users).

Certain exemplary embodiments can allow for actual synchronized interactions with products and/or components on the page, not just sending messages back and forth. Certain exemplary embodiments can provide a Product Chat component, which can be a chat-style messaging component that allows users to insert products into the chat dialog. This can insert a product identifier and/or reference into the message so that other users can easily see which product the user is talking about and click on it for more information. This method can insert a product reference that can be used to interact with other components of the page such as Product Details and/or Favorites.

Certain exemplary embodiments can provide:
a. synchronization in a product exploration application;
b. synchronized components that can show what remote users are doing in non-synchronized components (as can be done in our Shop Together User Component in Independent Exploration Mode);
c. the use of sub-session messaging threads (e.g., ID's) to create breakout groups from a main shared session that can synchronize in a different way from the main group (as in changing mode from Independent Exploration to Synchronized Exploration for some users but others, and/or allowing some users to be in one synchronized sub group, other users to be in another synchronized sub group, and still other users to be left in the main independent exploration group);
d. embedding objects into a chat-style messaging thread (as can be done in our Product-Based Chat);
e. the use of the same broadcast and subscription interfaces for message-based synchronization and state preservation, session preservation, logging, and/or session replay, etc.; and/or
f. access to other users' personalized resources in the connected instances of the application (as in our shared favorites, history, product notes, and/or product ratings).

Certain exemplary embodiments not only can track the user action, but also can send the state of the application components at the time the action occurred. This can allow the system to reconstruct not only what the user did, but what else was going on at the time (for example, they added a certain product to their shopping cart while they had filters checked for certain product attributes).

Certain exemplary embodiments can replay some user interactions in applications and/or pages created with highly interactive technology.

Certain exemplary embodiments comprise and/or provide an online system to assist users through the process of making a decision about which product(s) and/or service(s) best meet their needs among multiple options. Certain exemplary embodiments can be used in a single user independent mode and/or multi-user synchronized mode called Shop Together™.

Customers who shop and/or research online usually know that they need and/or desire something (perhaps a digital camera or a gift), but often do not know exactly which product to buy. These consumers typically receive little assistance with this critical “decision step” of the purchase process and often become frustrated and give up.

Common barriers to making an online purchase decision can include:
lack of product knowledge;
overwhelming number of options;
need to involve other decision-makers; and/or
desire to see, use, and/or experience the product in person.

Certain exemplary embodiments can provide embedded Rich Internet systems and/or software applications that can help users explore and/or evaluate their options on a retailer's and/or manufacturer's web site. Different exploration options for different types of users can help to improve the customer experience. Certain exemplary embodiments of the user interface can be configured in any of many varieties, such as a product selector, a gift finder, a buyer's guide, and/or a product configurator, etc.

One exemplary embodiment can provide assistance to an online consumer who visits a company's retail web site for the purpose of researching and/or buying a digital camera through the process of deciding which digital camera will best meet their needs. First the user can navigate via a Web browser or similar application to a site where an exemplary embodiment of the system has been incorporated. Upon encountering a page on the site where an exemplary User Interface of the exemplary application and/or system has been incorporated, the user could then interact with the system through the User Interface to receive information, education, recommendations, and/or assistance in evaluating the available product options with the purpose of facilitating the user's decision-making process, potentially leading to a higher rate of selection and/or sale of the products.

The User Interface can be implemented through alternate and/or multiple Web sites for a company and/or its affiliates, dealers, and/or partners. The User Interface can be implemented as a stand-alone system accessed through a kiosk and/or other similar computer system.

In a web-based and/or networked implementation, the user can have the ability to invite multiple friends and/or family members into a shared Shop Together session. The Shop Together session can be utilized by a customer service representative and an online consumer in different locations to view and/or interact with the same instance of an exemplary application while talking by telephone and/or chat.

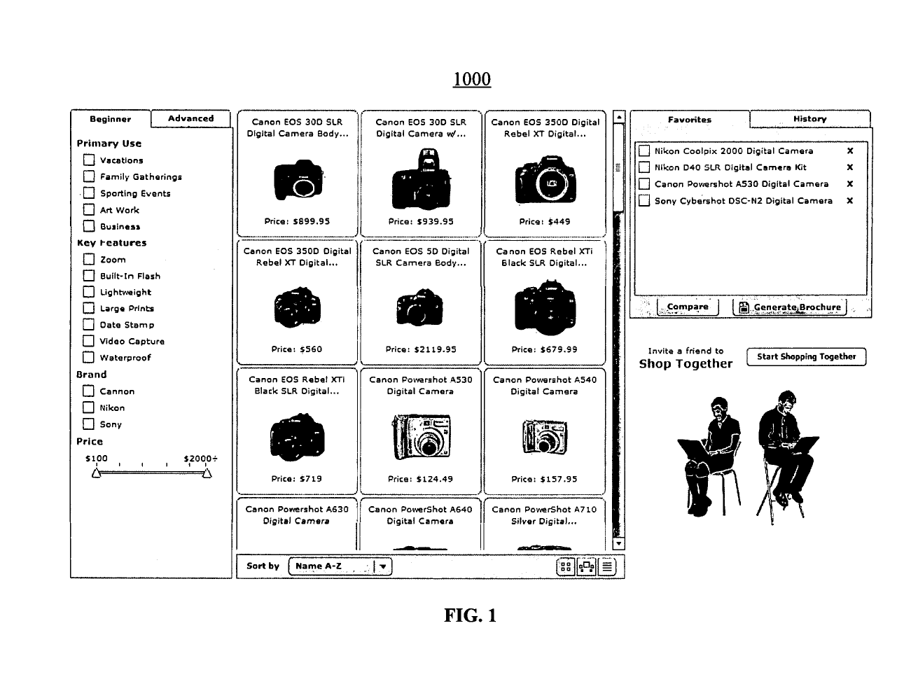

FIG. 1 is an exemplary illustration of an exemplary User Interface 1000 implemented for a digital camera selection. Certain exemplary User Interfaces can be built using highly interactive technology. The basic components of a exemplary standard User Interface can include:
Selection Criteria Component
Product Display Component
Favorites/History Component
Dynamic Brochure Generation
Personal Product Notes
Personal Product Ratings
   Descriptions of various exemplary embodiments of these components follow.

### Selection Criteria Component

The Selection Criteria Component can provide the user with a way to answer questions and/or express preferences about their needs and/or interests related to the products. The questions can be customized for each client and/or product implementation. Different questions can be displayed for different types of users, such as beginner and/or advanced questions. The format, layout, and/or design of this component can be customized as well.

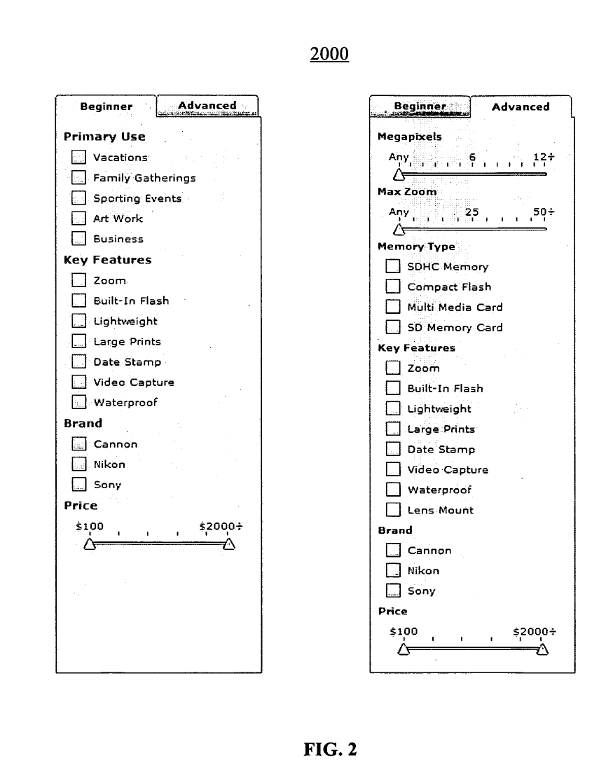

FIG. 2 is an exemplary illustration of a sample Selection Criteria Component 2000 showing two views with questions for two different types of users.

### Product Display Component

As the user makes selections in the Selection Criteria Component, different products can be displayed in the Product Display Component based on those selections. The format, layout, and/or design of this component can be customized for each client and/or product implementation, and/or can depend on what types of product information are displayed. When a user selects a specific product, additional information about that product can be displayed. In an e-commerce environment, products can be added to the shopping cart of the retailer's e-commerce system. Different views of the product list can be created, allowing users to choose how they want to view the available products. Examples of different product views can include:
Catalog View;
List View; and/or
Presentation View.

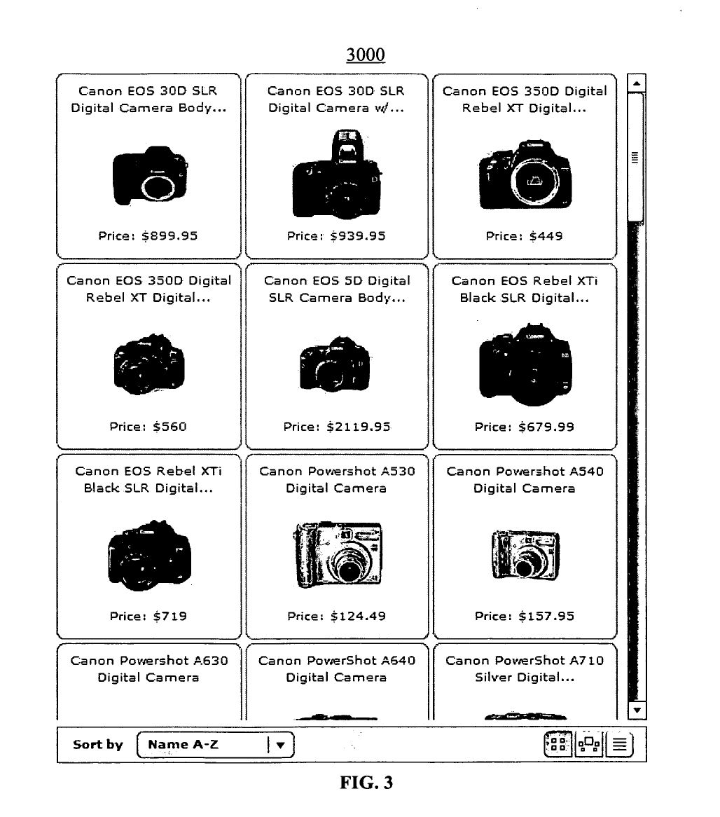

FIG. 3 is an exemplary illustration of a sample Catalog View 3000 of a Product Display Component.

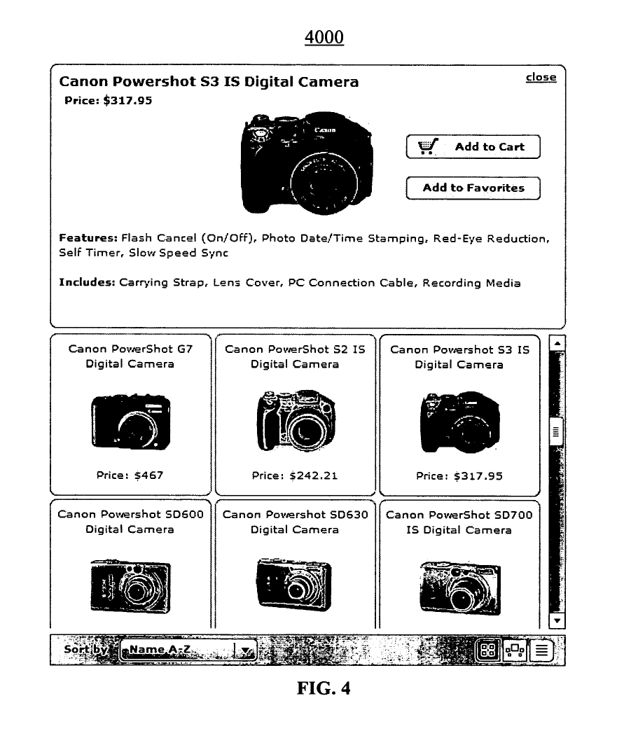

FIG. 4 is an exemplary illustration of a sample Catalog View 4000 of a Product Display Component showing details for a selected product.

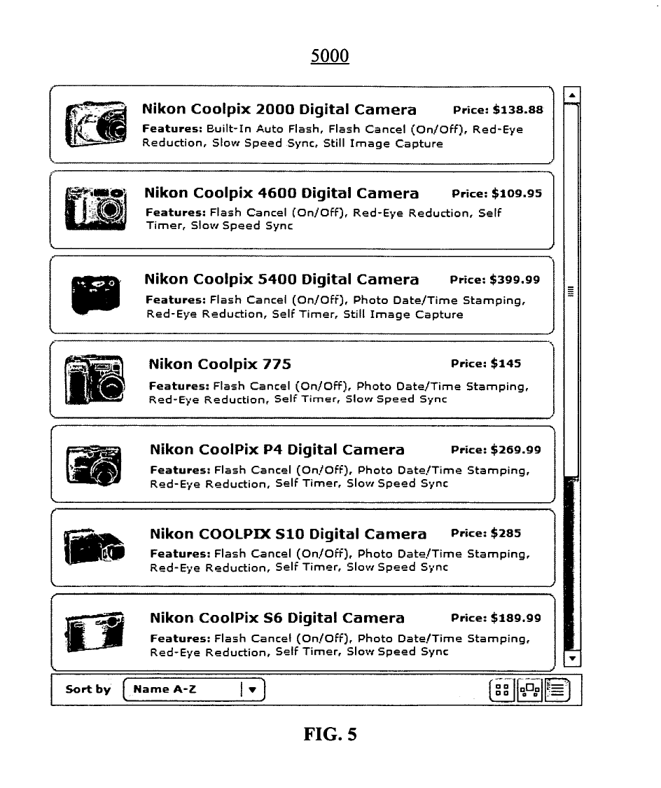

FIG. 5 is an exemplary illustration of a sample List View 5000 of a Product Display Component.

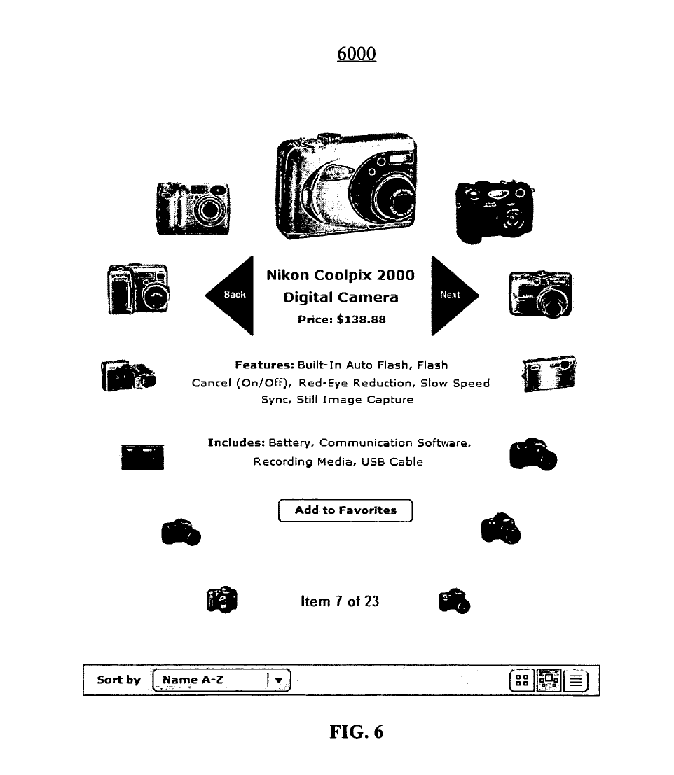

FIG. 6 is an exemplary illustration of a sample Presentation View 6000 of a Product Display Component.

The Presentation View can display a limited subset of products from the larger product list. As the user rotates through the products in the display, the next product in sequence can be pushed into the display and/or the last product can be popped out of the display. Each intermediate product can advance one step in the display. The center product can be made most prominent (by image size and/or other highlighting) and/or the product information and/or functionality for that product can be displayed. The leading and/or trailing products can be wrapped around the center product information. Each leading and/or trailing product image can be made slightly larger or smaller based on its position in the list to help drive focus to the center product. The Presentation View can help to address the difficulty that users can have in focusing on and/or evaluating one specific product at a time in more traditional views similar to a catalog or list view. Other patterns/shapes of product thumbnail placement in the display for this View can be used to create different user interactions with similar functionality.

### Favorites/History Component

Users can add products from the Product Display Component to the Favorites by clicking an Add to Favorites button and/or dragging and dropping the product into the Favorites area. The Favorites area can provide links to favorite products. The History area can provide links to recently viewed products. Clicking on a product link can display product information about that product in the Product Display component.

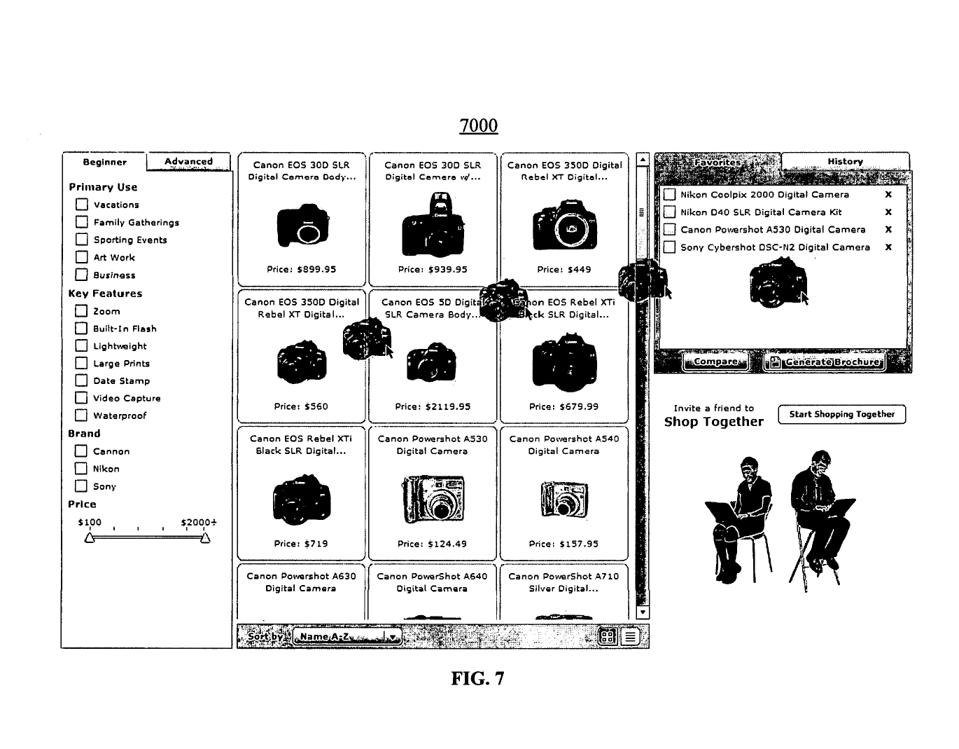

FIG. 7 is an exemplary illustration of user interface 7000 showing the dragging of a product to Favorites. Items that have been added to Favorites can be marked and/or sorted in the Product Display Component and/or selected with the Selection Criteria Component.

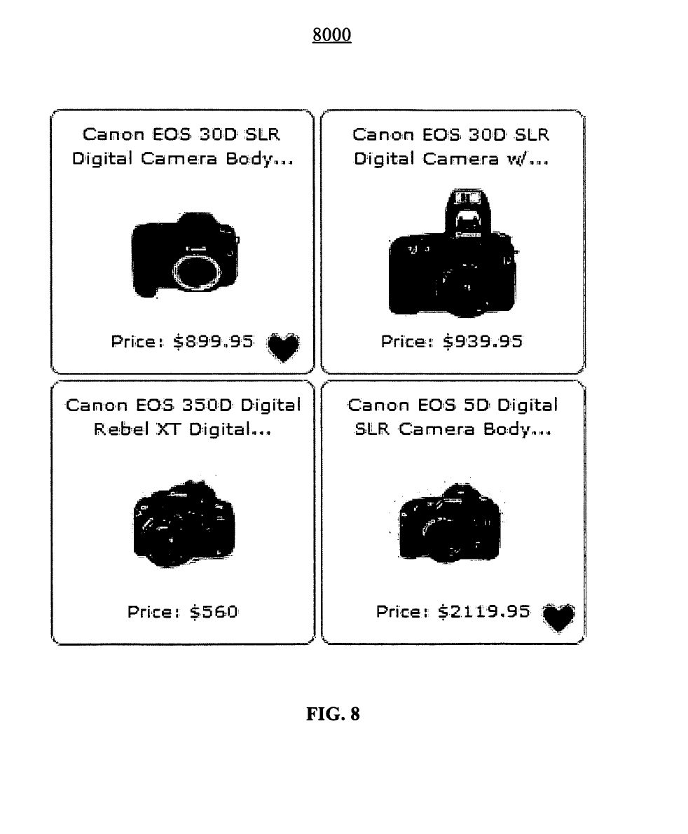

FIG. 8 is an exemplary illustration of a user interface 8000 showing products marked as favorites with a heart icon in an exemplary Product Display Component.

### Dynamic Brochure Generation

Users can create custom documents such as PDF files based on the products that they have added to Favorites and/or selected from the Product Display Component. These files can be downloaded, emailed, faxed, communicated, and/or sent to an on-demand digital printer for printing and/or mailing.

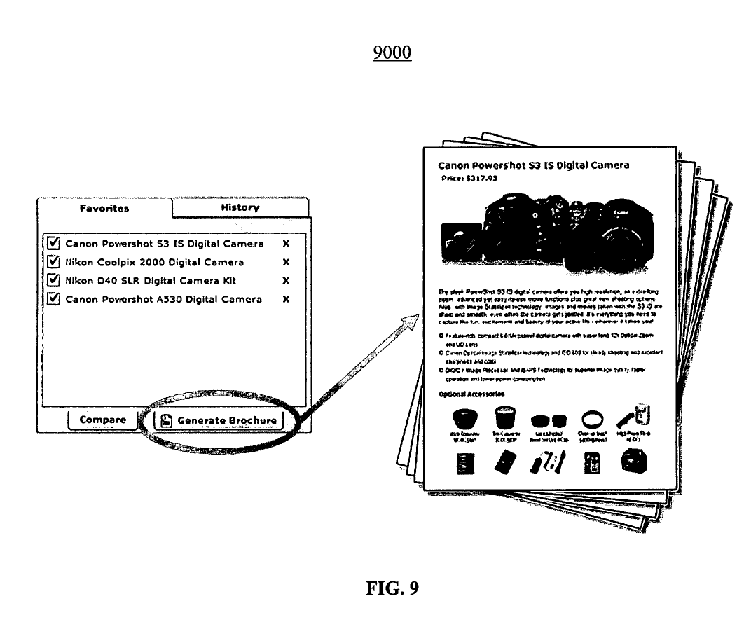

FIG. 9 is an exemplary illustration of a user interface 9000 showing the Generate Brochure button used to create a custom brochure from the Favorites Component.

### Personal Product Notes

Users can add personal notes to products in the Product Display Component. Items that have notes can be marked and/or sorted in the Product Display Component and/or selected with the Selection Criteria Component. Moving a pointer over the note icon can display the note.

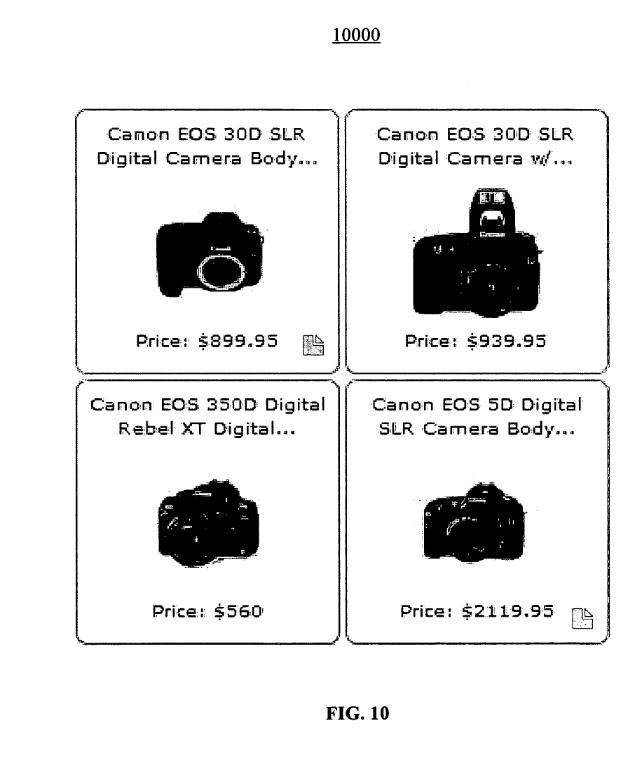

FIG. 10 is an exemplary illustration of a user interface 10000 showing products marked as having Personal Product Notes with a note icon in an exemplary Product Display Component.

### Personal Product Ratings

Users can add personal ratings to products in the Product Display Component. Items that have been rated can be marked and/or sorted in the Product Display Component and/or selected with the Selection Criteria Component.

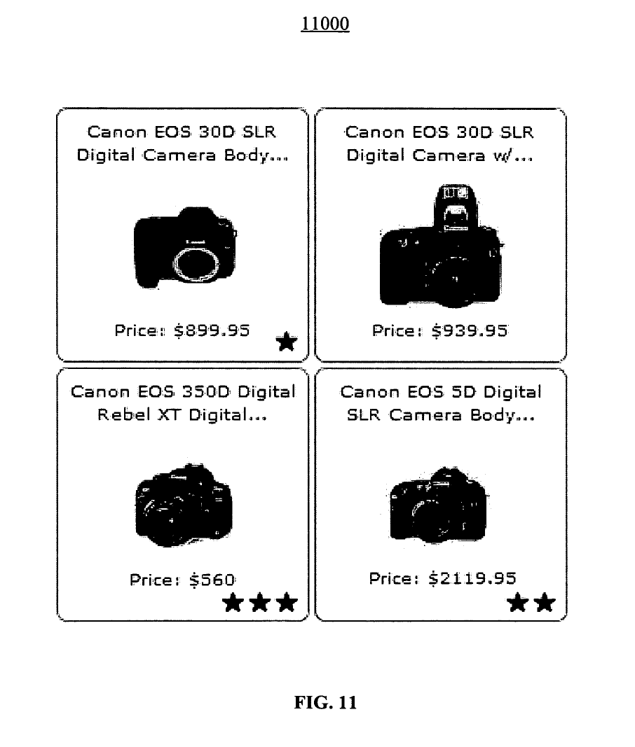

FIG. 11 is an exemplary illustration of a user interface showing products with Personal Product Ratings displayed with star icons in an exemplary Product Display Component.

### Shop Together™

For users who need and/or want the input of another person before deciding on a product, the Shop Together™ process can allow online shoppers to invite friends and/or family in different locations to interactively shop with them directly on a retailer and/or manufacturer web site.

This process can be utilized by a customer service representative and an online consumer in different locations to view and/or interact with the same instance of an exemplary application while talking by telephone and/or chat. For example, when a consumer calls into a call center with a question about a product, many call center staff use the web site of the company that manufactures and/or markets the product for information. Often the consumer is looking at the web site also. It can be difficult to talk about what each is seeing and difficult to direct the other person to particular products on that site. Using certain exemplary embodiments of the herein-described Shop Together process in a call center environment can make this a much more efficient process.

Virtually any number of users can join the same shopping session. Invited users can be given a session-specific URL by email, instant message, telephone, fax, submission into call management software, and/or other means. By directing a browser to that URL, the invited user can load an instance of the same application being used by the original user and the user sessions can be connected through the Shop Together server based on the session ID submitted with the session-specific URL. Alternatively, the Session ID code that is generated to link sessions can be displayed directly in the application so that User A can read just the Session ID to User B (or paste it into chat and/or some other method). User B can then enter the Session ID from User A directly into their instance of the application and the two can be synchronized.

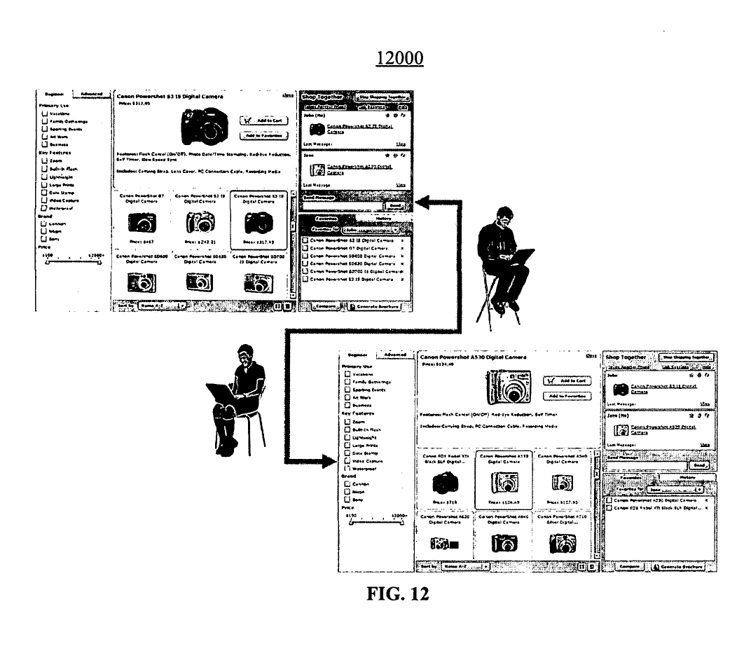

FIG. 12 is an exemplary illustration of a process 12000 involving two online users shopping together from different locations.

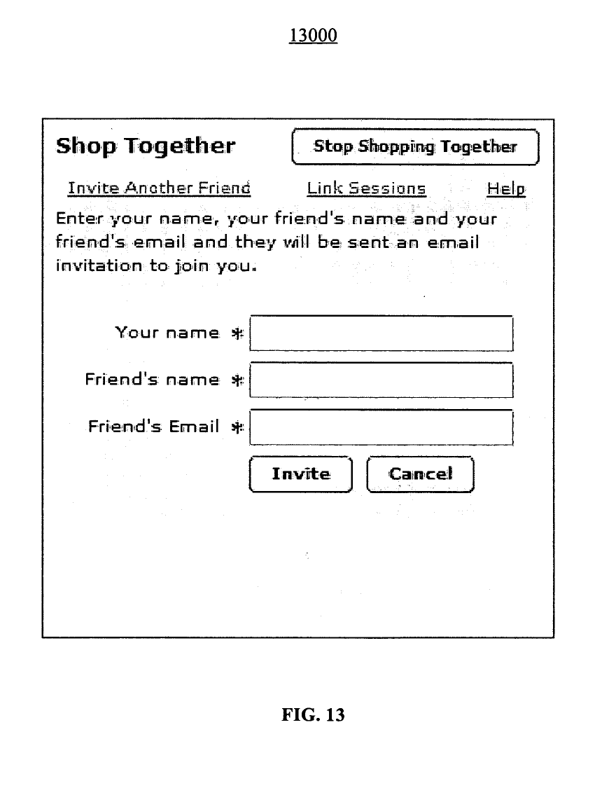

FIG. 13 is an exemplary illustration of an exemplary Shop Together Invitation Component 13000 that uses email to send the session-specific link to the invited user.

### Different Modes of Synchronization

Different components of each user's User Interface can be synchronized in real time in a shared session based on the configuration of different Shop Together modes. Examples of different modes can include:
Independent Exploration
Synchronized Exploration

Different (beyond these two exemplary) “Modes” of synchronization can be created by application and/or component-level rules that can determine which instances of components can broadcast and/or subscribe?.

### Independent Exploration Mode

In this mode, the Selection Criteria and Product Display Components for each user typically are NOT synchronized so each user can look for products independently. Each user typically can see what product the other user is viewing through the Shop Together User Component, which can be synchronized between all connected sessions. When a user clicks on the product being viewed by another user as displayed in the Shop Together User Component, that product can be displayed in the Product Display Component. The Favorites/History Component can function in multi-user mode so that an individual user can see Favorites and/or History for themselves, any other user, and/or all users combined. Personal Product Notes and/or Personal Product Ratings can be viewed for multiple users in the same manner.

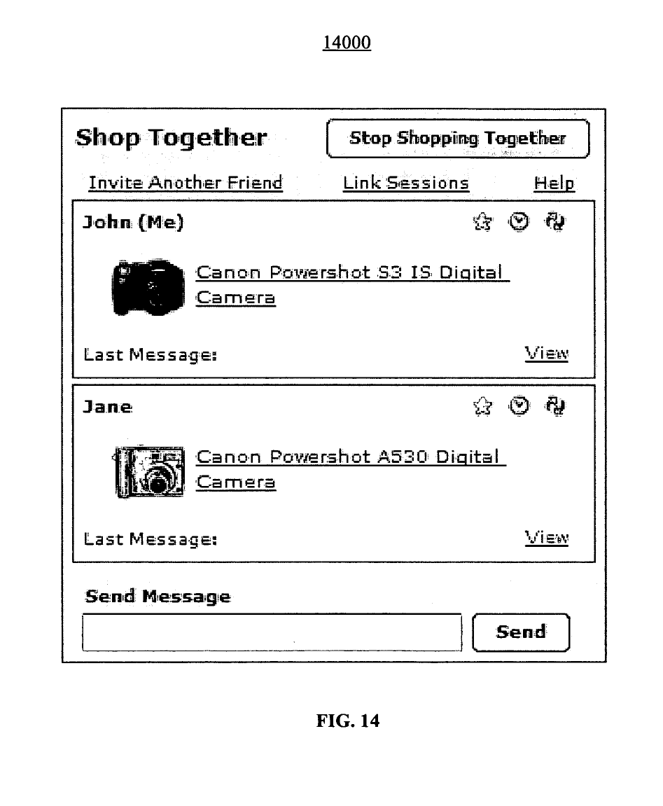

FIG. 14 is an exemplary illustration of a sample Shop Together User Component 14000 synchronized between two users in Independent Exploration Mode.

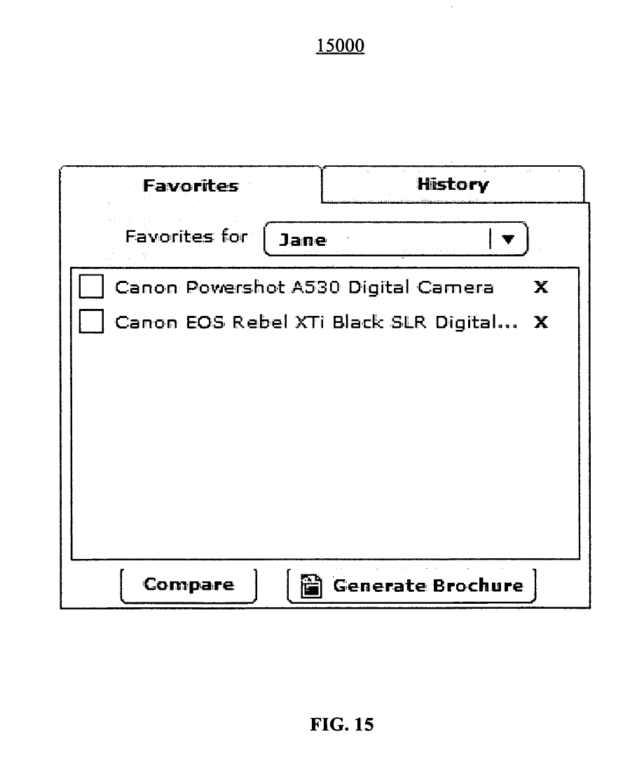

FIG. 15 is an exemplary illustration of a sample Multi-User Favorites/History Component 15000 synchronized between two users.

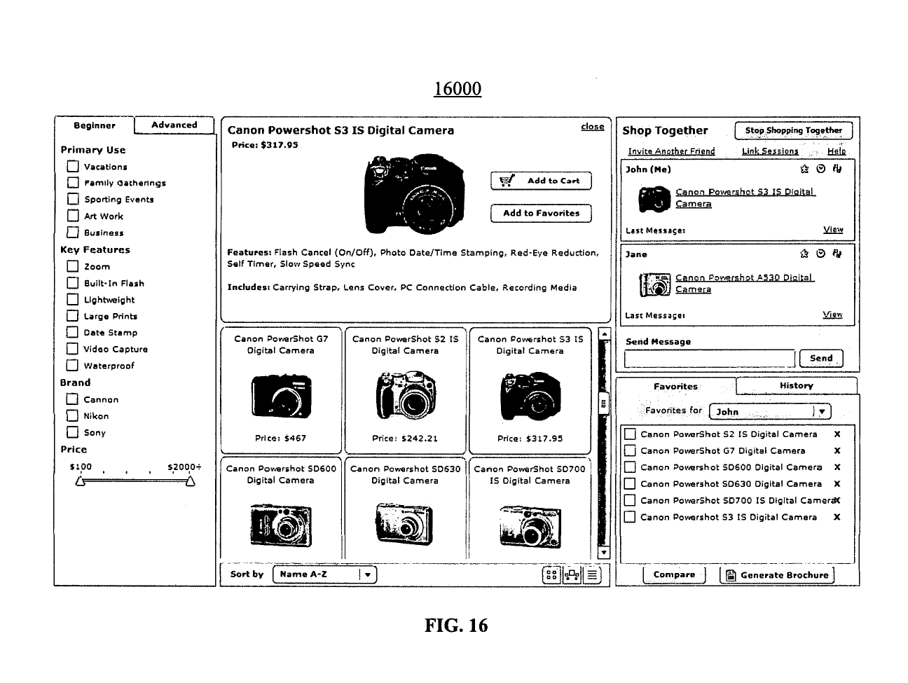

FIG. 16 is an exemplary illustration of a user interface 16000 comprising a sample Shop Together User Component and a sample Multi-User Favorites/History Component in the context of an exemplary User Interface synchronized in Independent Exploration Mode.

### Synchronized Exploration Mode

In this mode, the Selection Criteria and Product Display Components for each user typically ARE synchronized so each user can look for products together. Each user can see limited, any, and/or potentially all criteria selection and/or product display changes made by other users in real time.

In Synchronized Exploration Mode, users can be either Presenters or Viewers. A Presenter can be a user whose actions are broadcast to selected users and/or all other users so that those users see the changes made by the Presenter in any synchronized component. Viewers can subscribe to changes that are broadcast by a Presenter, but the Viewers' ability to make changes in synchronized components can be blocked in this mode, such that Viewers can only view Presenters' changes. A Viewer can request to become a Presenter. In the case of Single Presenter Mode, typically only one user can be a Presenter at any time and when another user is granted Presenter privileges, the current Presenter can become a Viewer. In Multiple Presenter Mode, any number of users can be Presenters at the same time and all of their actions can be broadcast to all synchronized users.

The Favorites/History Component can function in multi-user mode so that an individual user can see Favorites and/or History for themselves, any other user, and/or all users combined. Personal Product Notes and/or Personal Product Ratings can be viewed for multiple users in the same manner. In Synchronized Exploration Mode, all users can add products to their own Favorites Component and/or can add their own Personal Product Ratings and/or Personal Product Notes.

Transition between Different Shop Together Modes

The Shop Together session can start in one mode with users having the ability to transition in and out of another mode. The transition can affect which type of Shop Together User Component is used and which components of the application are synchronized between users. For example, several users can start out in Independent Exploration Mode. Two or more of them could then transition into Synchronized Exploration Mode, leaving the others still in Independent Exploration Mode. Multiple groups in the same Shop Together Session can break out into different Synchronized Modes, so that two users can be synchronized in one sub-session, while two others are synchronized in another sub-session. The remainder can still be in Independent Exploration Mode.

The Shop Together session can start in one mode, such as Synchronized Exploration Mode, and only allow users to participate in that mode.

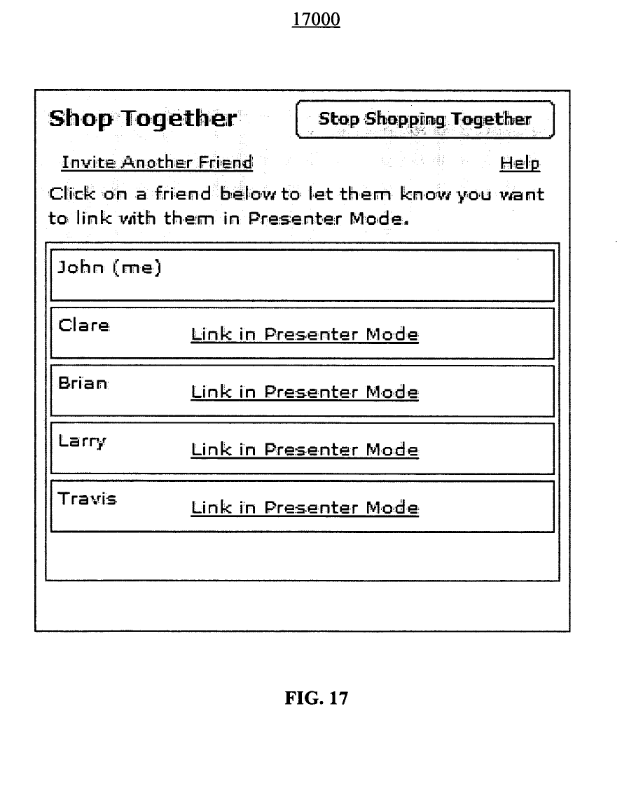

FIG. 17 is an exemplary illustration of a sample Shop Together User Component 17000 synchronized between multiple users in Synchronized Exploration Mode where the user John is able in invite other users to link with him in Synchronized Exploration Mode (here labeled Presenter Mode). The other users are still currently in Independent Exploration Mode.

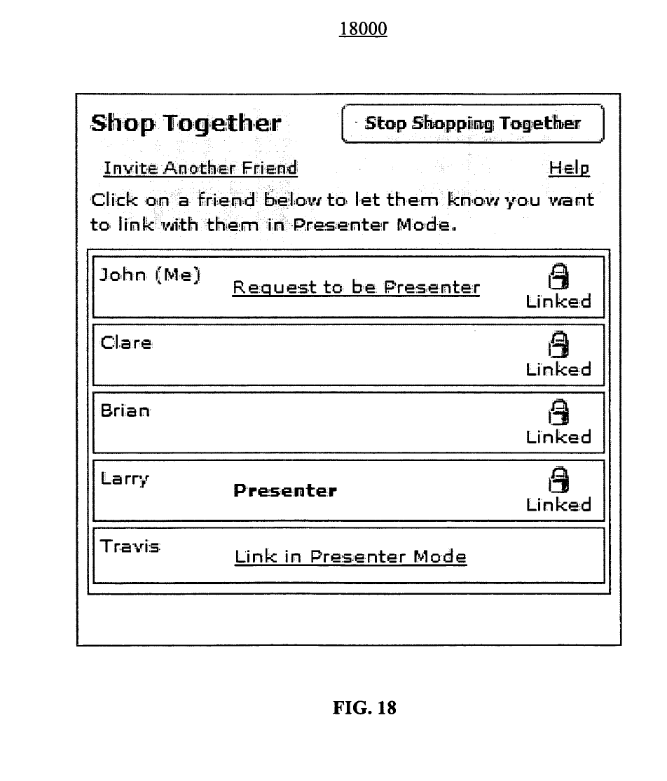

FIG. 18 is an exemplary illustration of a sample Shop Together User Component 18000 synchronized between multiple users in Synchronized Exploration Mode where the user John is a Viewer in Single Presenter Mode. Larry is the Presenter. Clare and Brian are also Viewers. Travis is still exploring independently.

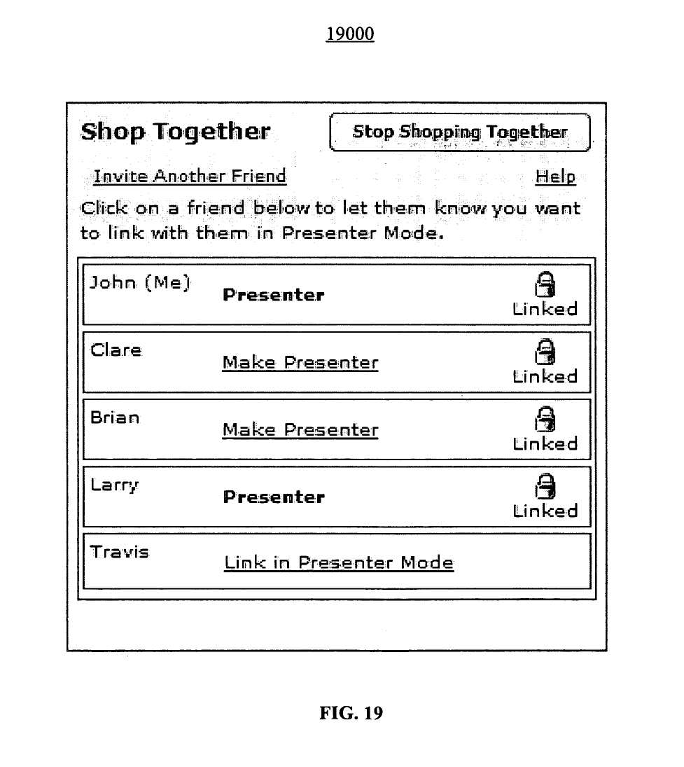

FIG. 19 is an exemplary illustration of a sample Shop Together User Component 19000 synchronized between multiple users in Synchronized Exploration Mode where the user John is a Presenter in Multiple Presenter Mode. Larry is also a Presenter. Clare and Brian are Viewers. Travis is still exploring independently.

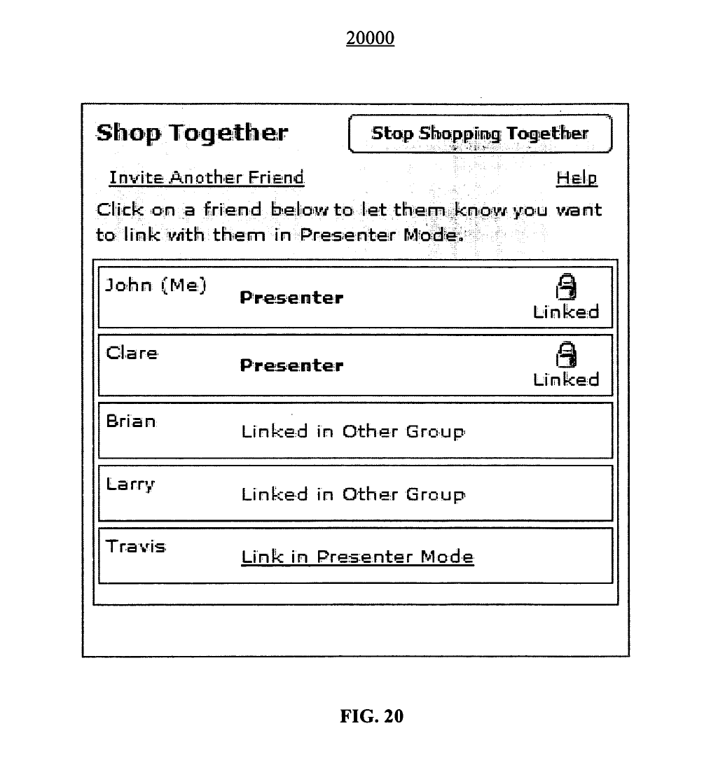

FIG. 20 is an exemplary illustration of a sample Shop Together User Component 20000 synchronized between multiple users in Synchronized Exploration Mode where the user John and Clare and synchronized in one sub-session and Brian and Larry and synchronized in another sub-session. Travis is still exploring independently.

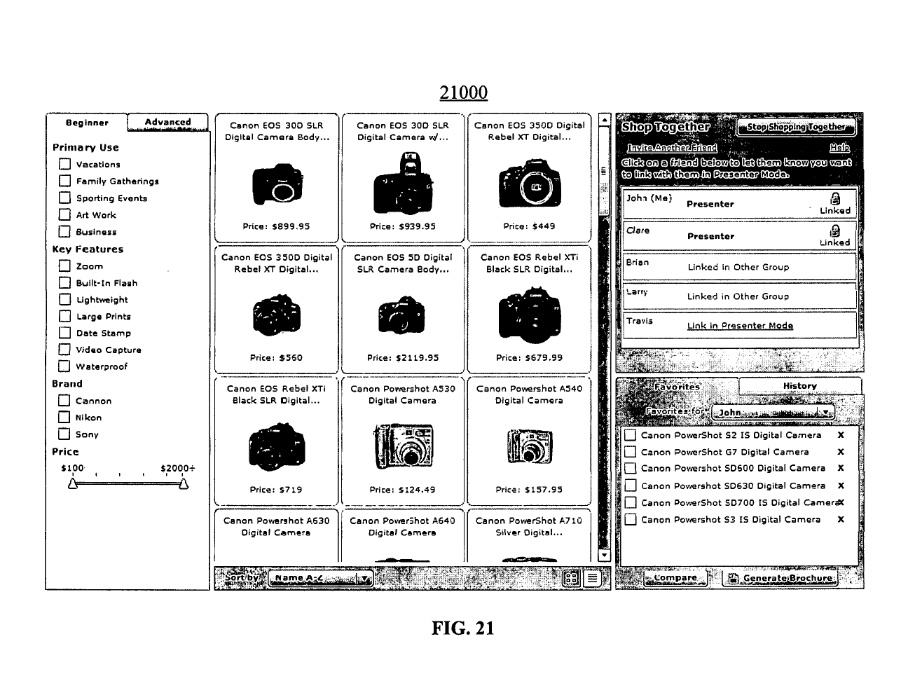

FIG. 21 is an exemplary illustration of user interface 21000 comprising a sample Shop Together User Component and a sample Multi-User Favorites/History Component in the context of an exemplary User Interface synchronized in Synchronized Exploration Mode.

### One-Time Component Synchronization

Automatically—When users start shopping together in an application and/or change modes so that a new component is now synchronized which was previously functioning in an independent mode, the newly linked user can first have a one-time full synchronization of all previously independent components. The list of components to be synchronized can depend on which Shop Together Mode of Synchronization they are in. For example, in Synchronized Exploration Mode the Selection Criteria Component and/or the Product Display Component can undergo a one-time synchronization. After that point, each Presenter action can be broadcast and/or each change can be incrementally made on all subscribed instances of the application in the Shop Together session to keep them synchronized.

Manually—A user can use manual one-time synchronization to update their shared components to match the current state of another user's components, but then continue independently using the components from that point. In this case, the subsequent action-level publication and/or subscription need not be implemented, and typically, only the initial one-time synchronization would be implemented. For example, a user in Independent Exploration Mode can click on a link to manually synchronize with another user in their Shop Together session. In this case, the Selection Criteria Component and/or Product Display Component can be synchronized to match the state of those components for the other user. The users typically would not change modes to Synchronized Exploration Mode, however, but typically would continue in Independent Exploration Mode starting from the same point.

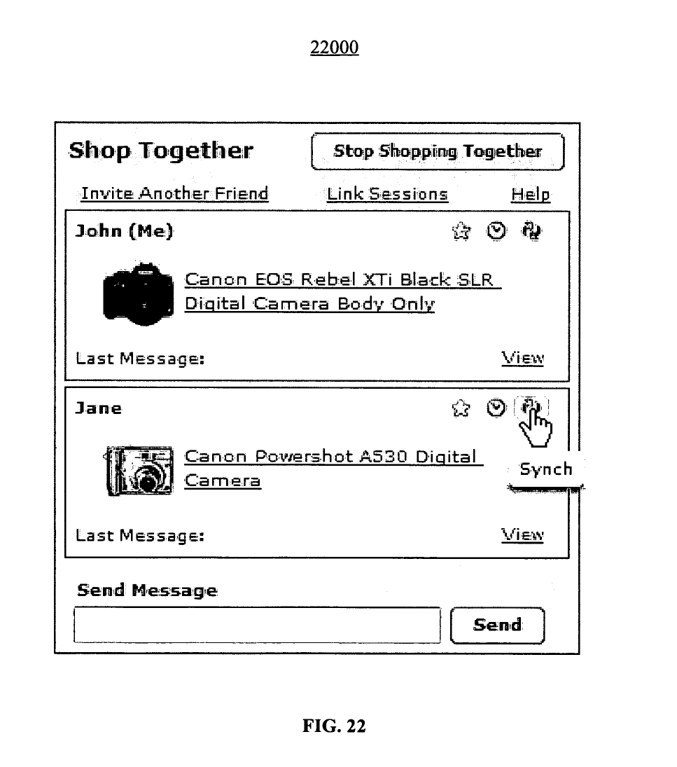

FIG. 22 is an exemplary illustration of a sample Shop Together User Component 22000 synchronized between two users in Independent Exploration Mode where John is clicking on the link for One-Time Synchronization with Jane.

### Product-Based Chat Component

Certain exemplary embodiments can have the capability for chat-style communication between the users in the Shop Together session. This component can allow users to insert product references into the chat message stream by clicking something similar to an Insert Product checkbox and/or button when sending a message. The product reference then can be sent as a message from the user and/or displayed as a product thumbnail to other users in the chat message stream, potentially along with standard text messages. The product thumbnail can display information such as the product name, product image, and/or product price, etc. When a user clicks on the product thumbnail, additional product information can be displayed in another component such as the Product Display Component, similar to clicking on a product in the Favorites or History list.

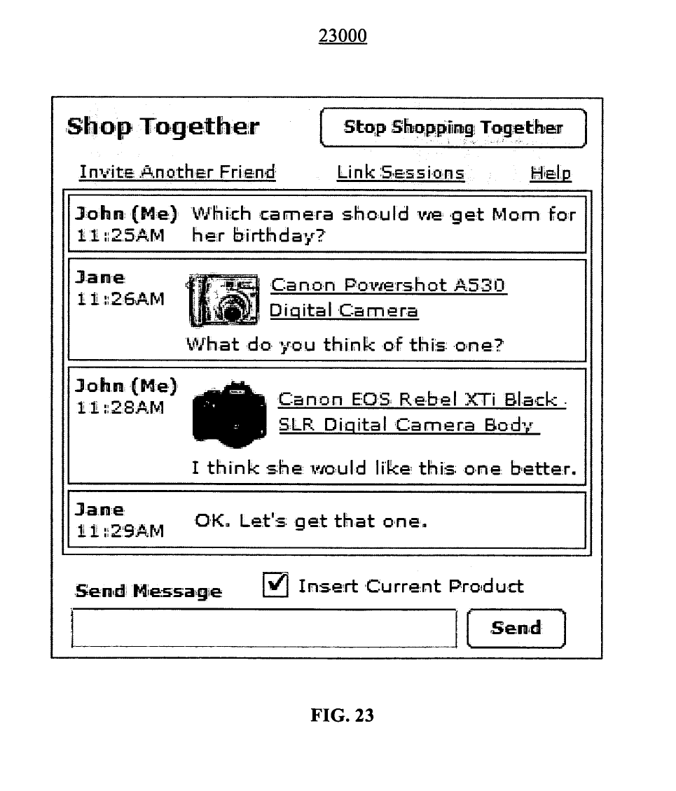

FIG. 23 is an exemplary illustration of a sample Shop Together Product-Based Chat Component 23000 between two users in Independent Exploration Mode.

### Component Interfaces

To facilitate Shop Together and other functionality, each component can have any of several programmatic interfaces, exemplary embodiments of which will be described below, including:
State Broadcast;
State Subscription;
Event Broadcast;
Event Subscription;
Event & State Broadcast; and/or
Event & State Subscription.

### State Broadcast Interface

When this component interface is called, the component can return the state of selected and/or each object in the component, potentially including the values of any relevant object properties. The object and/or property values sent can be those necessary to set another instance of the component to the same state as the instance of the component whose state is currently being broadcast. The transmission can be limited to only differences between the default state of the component and the current state. For example, if Checkbox A is checked in Instance 1 of a component, then Instance 1 can return the fact the Checkbox A is checked when the State Broadcast Interface is called. If the default state of Checkbox B is unchecked and Checkbox B is still unchecked in Instance 1, then Instance 1 of the component need not return any reference to Checkbox B since that information would not be needed to change Instance 2 of the component from its default state to match the state of Instance 1. Instance 1 could return the state of Checkbox B for the sake of redundancy. An application can combine the State Broadcast returns from multiple components to create a complete profile of the overall state of the application at a given time. The format of the return information can be in a delimited list of values and/or any other manner in which the relationships between objects, properties, and/or values can be preserved and/or communicated in the return.

### State Subscription Interface

When this component interface is called, the component can be sent information in a similar format as returned by the State Broadcast Interface. This can allow the component to set its objects and/or object properties to the values sent to it in the State Subscription Interface call. Any object property for which information is not sent can revert to the default property settings for the component. This connection between the information returned by the State Broadcast Interface and the State Subscription Interface can allow for the state-level synchronization of components through Shop Together and/or other methods.

### Event Broadcast Interface

This Interface can be similar to the State Broadcast Interface, but can return only information for a specific event, such as the action of a user clicking a checkbox. In this case, the event name and/or any necessary values can be returned. The format of the return information can be in a delimited list of values and/or any other manner in which the relationships between event, objects, properties, and/or values can be preserved and/or communicated in the return.

### Event Subscription Interface

When this component interface is called, the component can be sent information in a similar format as returned by the Event Broadcast Interface. This can allow the component to respond as if the event referenced in the Event Subscription Interface call had happened locally. For example, if the information sent in the Event Subscription call indicates that an action should occur in which Checkbox A is checked, then Checkbox A in the local component can be checked and/or any associated local events and/or other actions that would normally be triggered by the local action of checking Checkbox A can be triggered by the checking of Checkbox A through a call to the Event Subscription Interface. This connection between the information returned by the State Broadcast Interface and the State Subscription Interface can allow for the event-level synchronization of components through Shop Together and/or other methods.

### Event & State Broadcast Interface

This interface can provide a pairing of the information returned from the State Broadcast Interface and the Event Broadcast Interface. The purpose can be to preserve the relationship between an event occurring and the state of the application at the time the event occurred. This information can provide valuable insights into what users are doing with the application and/or what they were seeing at the time. For example, a user might click on Checkbox A to check it. Using this interface, the event of clicking on Checkbox A can be broadcast (as in the Event Broadcast Interface), potentially along with the fact that Checkbox B was currently checked at the time that the user clicked Checkbox A.

### Event & State Subscription Interface

This interface can receive a pairing of the information formatted similar to the return from the State Broadcast Interface and the Event Broadcast Interface. First the state-level settings can be implemented and then the specific event-level action can be triggered.

### Interface Implementation

The programming environment for any interface can be the same highly interactive technology that the component itself is written in.

The interface technique can involve a triggering action and a response (similar to a function call and function return). For example with the Event Broadcast interface, if a user clicked on Button #1 in a component, that can be the “action”, and the “response” can be a return from the interface (perhaps as a delimited string) that indicates that Button #1 was clicked. The actual impact of the user's click of Button #1 can be handled within the component with an Event Function called by the user's click that would contain the logic for any changes to the component (and/or data) based on the user's action. In Synchronized Exploration Mode (for example), an event listener function can monitor any responses from the Event Broadcast interface for the component. When this listener detects a change, it can forward the response to other synchronized instances of the application using the messaging protocols described herein.

The Event Subscription interfaces in these other synchronized instances can be listening for the response through messaging. When the response is received by the Event Subscription interface, it can trigger the Event Function in the component, which can execute the logic in the synchronized component as if the user of that component had clicked on their instance of Button #1. In this implementation we effectively can allow User A to click Button #1 in User B's component from a remote location by clicking Button #1 in their own (User A's) instance of the component. Similar techniques can be used to send (and/or retrieve) an event to/from a log file, cookie, and/or database.

The difference between different “Modes” of Shop Together can be a question of which components are broadcasting and/or subscribing to what events. The difference between the Event and State interfaces can be a question of scope. The Event interfaces can send the fact that an action has occurred, potentially along with information about that action. The State interfaces can send the current state of all, many, and/or some of the user interface and/or data objects in the component at the time the State interface is invoked. For example, the State Broadcast interface when called can return the fact that Checkbox #1 is currently checked, Tab #1 is currently selected, and/or Index #5 in the product data array is currently selected, etc. When this information is received through the State Subscription interface, some, any, and/or all of these objects in the synchronized instance can be set to the state indicated by the response (e.g., Checkbox #1 can be checked and any events associated with this action can be triggered). This can allow us to set the state of User B's version of a component to the exact state of User A's version of the component through messaging. We can restore User A's version of the component to a state from a previous point in time by retrieving the state settings from a log file, cookie, and/or database and/or sending them to the State Subscription interface. The combined Event & State interfaces can function like the Event interfaces, but can pass all of the State information with the Event information in one response. This can allow us to record that an event occurred, potentially along with the context in which that event occurred (e.g., the state of the component at the time the event occurred). With the Event & State Subscription method, we can trigger an event (such as clicking Button #1) and/or set some, any, and/or all of the other objects in the component to their appropriate state with one call. The state and/or event interfaces can be used to communicate between two different components in the same instance of the application.

### Shop Together Component Interaction

Shop Together can connect component level interactions across multiple instances of components and/or applications on different computers that can be connected by the Internet and/or a network. The information returned from a broadcast-type interface call can be broadcast to other components through a messaging system similar to that found in Adobe Flex 2. Applications and/or components that have subscribed to the same session or sub-session of the messaging system can receive the broadcasted information and/or can implement it through the corresponding subscription interface. This can allow applications and/or component for multiple users to be synchronized in real time. The determination of which instances of components will broadcast or subscribe or both can be made by application and/or component-level rules such as what Shop Together Mode is currently being used and/or what the user's role is (for example Presenter or Subscriber).

### Component State Preservation

Using the broadcast and subscription model, the current state of the application can be saved either locally in a cookie and/or similar format and/or can be saved on the server tied to the user's session. When the application loads again upon refresh, the application can check for the existence of saved state information and/or reset itself by sending that saved information to the appropriate State Subscription Interface(s). In this way, state can be synchronized in the same instance of an application across time rather than in two different instances across space as is done through the real-time Shop Together Component Interaction.

### Session Activity Tracking

By sending the returns from the State Broadcast and Event Broadcast Interfaces (or the combined interface) to a tracking server, user activity can be logged and/or later analyzed and/or used to create reports. By preserving the relationship between the event and the state in each submission to the tracking logs, more information can be collected and/or analyzed about the context of the application state in which each user action occurred.

### Replaying Session Activity

Because the tracking logs can contain the state and/or event returns from the broadcast interfaces stored in chronological order, this information can be sent to the subscription interfaces of an instance of the application to trigger the same user actions in the order that they actually occurred. By referencing the time interval between each logged action and/or inserting the appropriate lag between each action submitted to the subscription interfaces, one can effectively replay any logged user session and/or view the interactions of the user to see what they did and/or where they may have run into issues.

### Process Flow

The attached document provides an exemplary illustration of an exemplary basic process flow. In general, the components of the User Interface can be served upon request from the Application Server to a User's browser and/or other similar client-side application. The product data and/or images then can be requested by the client-side user interface application and/or served from the Data & Imaging Server. User-initiated events (potentially along with state information) can be sent to the Event & State Tracking Server where it can be logged (and/or processed for reporting). User events (and/or state information) can be sent between multiple synchronized users through the messaging server. Dynamic brochures can be created, downloaded, emailed, and/or otherwise communicated upon request from the Dynamic Brochure Server. The Reporting & Content Administration Application can give clients access to reports and/or administrative functionality for their application and/or data. Typically, all data can be stored on the servers, with the possible exception of user and/or session IDs that can be stored in a cookie (and/or similar format) on the client-side computer. Session state information for session preservation can be stored on the client-side computer. It is also possible for user, session, and/or state information to be stored on the server side and accessed with a login, user ID, and/or other similar method.

Additional potential simplified process flow descriptions are provided below.

Scenario #1 (Single-User Product Selection) can comprise activities such as:
1. (shopping) session initiated;
2. session recorded and/or tracked;
3. questions answered and/or relevant products explored;
4. product details viewed;
5. product selected and/or added to cart and/or purchased;
6. session ended;
7. session replayed; and/or
8. session analyzed

Scenario #2 (Multi-User Product Selection) can comprise activities such as:
1. (shopping) session initiated;
2. session recorded and/or tracked;
3. another user(s) invited to view/engage in session;
4. application state synchronized between each instances;
5. questions answered and/or relevant products explored;
6. user actions synchronized between each instance;
7. product selected and/or added to cart and/or purchased;
8. session ended; and/or
9. session analyzed.

Scenario #3 (Single-User State Preservation) can comprise activities such as:
1. (shopping) session initiated;
2. questions answered and/or relevant products explored;
3. user preferences and/or application state saved;
4. session ended;
5. session restarted at later time;
6. user preferences and/or application state reloaded;
7. questions answered and/or relevant products explored;
8. product selected, added to cart, and/or purchased; and/or
9. session ended.

### Component Connections

The attached document provides an exemplary illustration of exemplary component connections. There are three diagrams that show the same exemplary Broadcast and Subscription Interfaces used for exemplary embodiments of the Shop Together, Activity Tracking, and State Preservation processes.

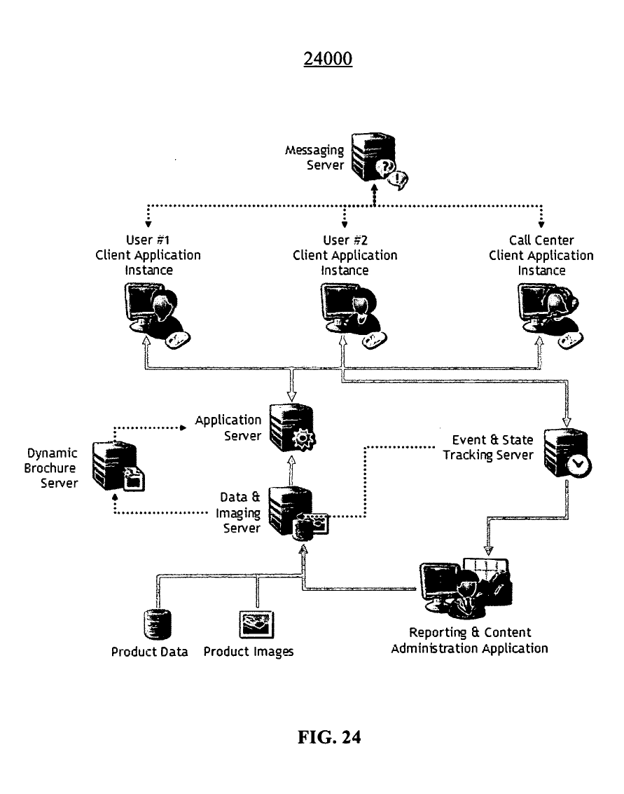

FIG. 24 is a block diagram of an exemplary embodiment of a system 24000.

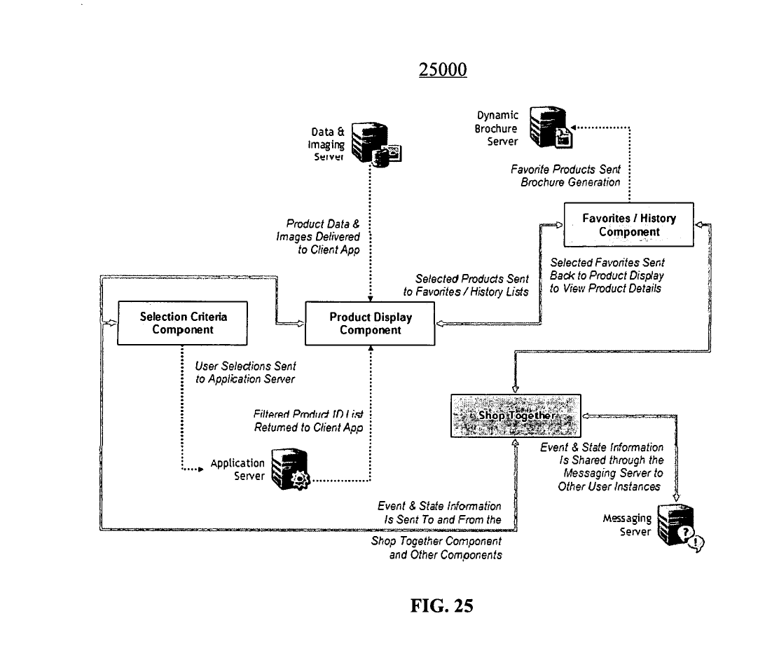

FIG. 25 is a block diagram of an exemplary embodiment of a system and Shop Together process 25000.

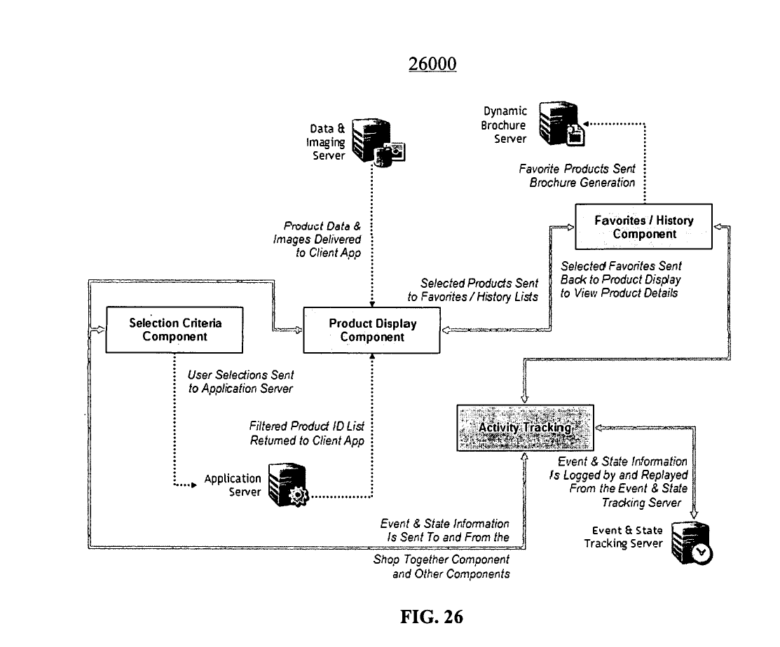

FIG. 26 is a block diagram of an exemplary embodiment of a system and Activity Tracking process 26000.

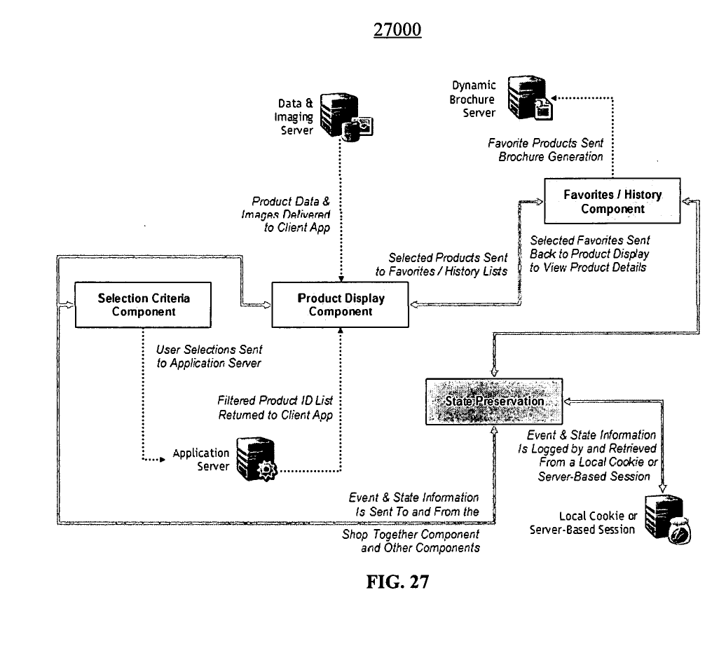

FIG. 27 is a block diagram of an exemplary embodiment of a system and State Preservation process 27000.

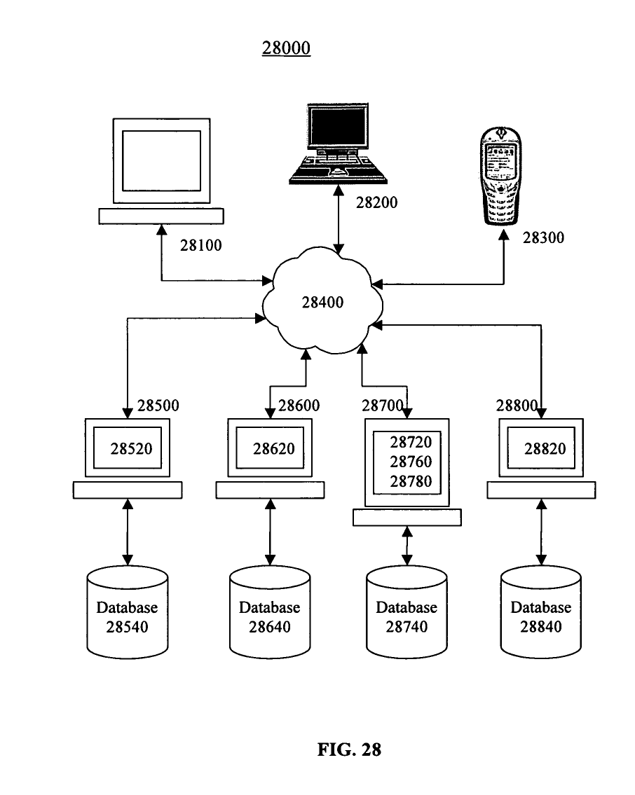

FIG. 28 is a block diagram of an exemplary embodiment of a system 28000, which can comprise any number of information devices 28100, 28200, 28300, which can be communicatively coupled via a network 28400.

Also coupled to network 28400 can be any number of servers 28500, 28600, 28700, 28800. A server can include a server software application 28520, 28620, 28720, 28820. A server can be coupled to a data storage device, repository, and/or database 28540, 28640, 28740, 28840. A server can include an administrator user interface 28760 and/or database management software 28780.

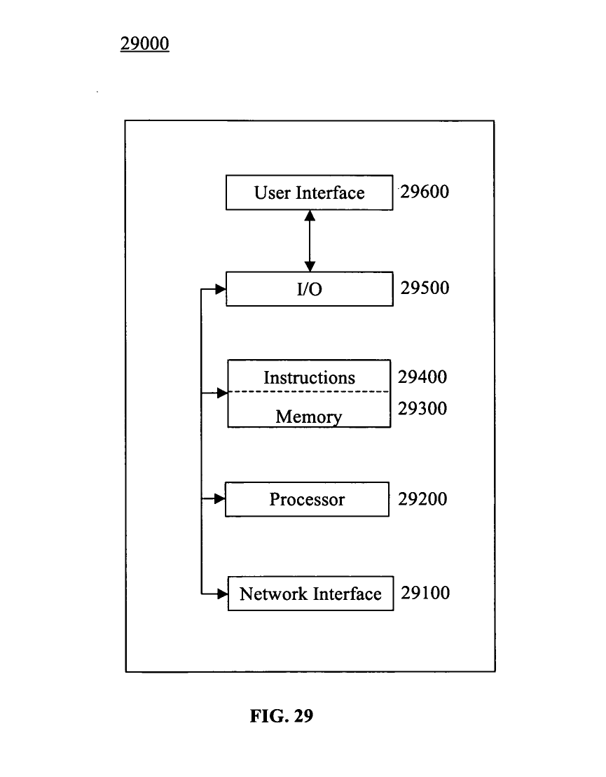

FIG. 29 is a block diagram of an exemplary embodiment of an information device 29000, which in certain operative embodiments can comprise, for example, server 28500, 28600, 28700, 28800, and/or information device 28100, 28200, 28300, of FIG. 28. Information device 29000 can comprise any of numerous circuits and/or components, such as for example, one or more network interfaces 29100, one or more processors 29200, one or more memories 29300 containing instructions 29400, one or more input/output (I/O) devices 29500, and/or one or more user interfaces 29600 coupled to I/O device 29500, etc.

In certain exemplary embodiments, via one or more user interfaces 29600, such as a graphical user interface, a user can view a rendering of information related to researching, designing, modeling, creating, developing, building, manufacturing, operating, maintaining, storing, marketing, selling, delivering, selecting, specifying, requesting, ordering, receiving, returning, rating, and/or recommending any of the products, services, methods, and/or information described herein.

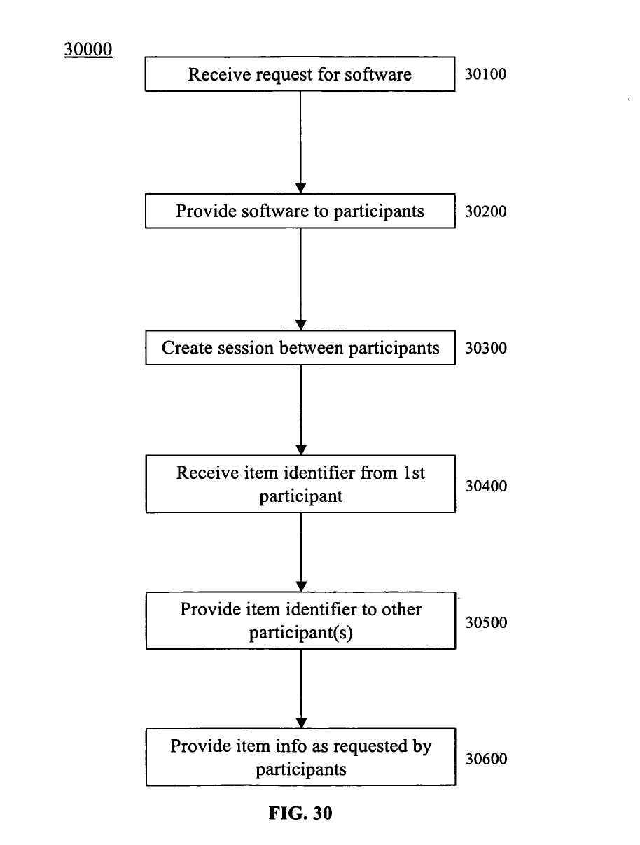

FIG. 30 is a flowchart of an exemplary embodiment of a method 30000. At activity 30100, a request can be received to provide software, such as product selection software, to potential participants in a Shop Together session. For example, the request can be received at a server from an information device of one or more of the potential shoppers. At activity 30200, the software can be provided to one or more of the potential participants. For example, the server can provide product selection software to an information device of one or more of the potential shoppers. At activity 30300, a communication session can be created between two or more potential participants. For example, the server can create a session between a first information device and a second information device. At activity 30400, an identifier, such as a product identifier, can be received, such as by the server, from a first potential participant, such as a first information device. At activity 30500, the received identifier can be provided, such as by the server, to one or more other potential participants, such as the second information device, in the session. At activity 30600, as requested, such as by a potential participant and/or information device, information associated with the identifier, such as information associated with a selected product, can be provided, such as by the server, to the requester.

Thus, certain exemplary embodiments can provide a method that can include: sending software to a first information device and to a second information device, the software adapted to cause display of information regarding user-selected items; receiving an identifier of a selected item; and providing the identifier to the software on the second information device.

More particularly, certain exemplary embodiments can provide a method that can include: from a server, sending product selection software to a first information device and to a second information device, said product selection software adapted to cause display of information regarding user-selected items; via said server, creating a communication session linking said first information device to said second information device; at said server, from said product selection software running on said first information device, receiving an identifier of a selected item; and from said server, providing said identifier to said product selection software running on said second information device, receipt of said identifier by said product selection software running on said second information device adapted to cause information associated with said selected item to be rendered via said second information device.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, deed, function, step, and/or process and/or a portion thereof.
adapted to—suitable, fit, and/or capable of performing a specified function.
and/or—either in conjunction with or in alternative to.
apparatus—an appliance or device for a particular purpose
associated—related to and/or accompanying.
automatically—acting or operating in a manner essentially independent of external influence or control. For example, an automatic light switch can turn on upon “seeing” a person in its view, without the person manually operating the light switch.
can—is capable of, in at least some embodiments.
cause—to bring about, provoke, precipitate, produce, elicit, be the reason for, result in, and/or effect.
circuit—an electrically conductive pathway and/or a communications connection established across two or more switching devices comprised by a network and between corresponding end systems connected to, but not comprised by the network.
communication—a transmission and/or exchange of information.
comprising—including but not limited to, what follows.
create—to make, form, produce, generate, bring into being, and/or cause to exist.
data—distinct pieces of information, usually formatted in a special or predetermined way and/or organized to express concepts.
data structure—an organization of a collection of data that allows the data to be manipulated effectively and/or a logical relationship among data elements that is designed to support specific data manipulation functions. A data structure can comprise meta data to describe the properties of the data structure. Examples of data structures can include: array, dictionary, graph, hash, heap, linked list, matrix, object, queue, ring, stack, tree, and/or vector.
device—a machine, manufacture, and/or collection thereof.
display—(v.) to visually render. (n.) an electronic device that represents information in visual form and/or a visual representation of something.
from—used to indicate a source.
further—in addition.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
identifier—a group of symbols that are unique to a particular entity, object, activity, service, relationship, characteristic, and/or document. An identifier can be, for example, a medical record number. An identifier can be human and/or machine readable and/or understandable, such as for example, a number, alphanumeric string, code, bar code, RFID, etc.
implement—to attempt to accomplish some aim and/or execute some order.
information—facts, terms, concepts, phrases, expressions, commands, numbers, characters, and/or symbols, etc., that are related to a subject.

Sometimes used synonymously with data, and sometimes used to describe organized, transformed, and/or processed data. It is generally possible to automate certain activities involving the management, organization, storage, transformation, communication, and/or presentation of information.
information device—any device on which resides a finite state machine capable of implementing at least a portion of a method, structure, and/or or graphical user interface described herein. An information device can comprise well-known communicatively coupled components, such as one or more network interfaces, one or more processors, one or more memories containing instructions, one or more input/output (I/O) devices, and/or one or more user interfaces (e.g., coupled to an I/O device) via which information can be rendered to implement one or more functions described herein. For example, an information device can be any general purpose and/or special purpose computer, such as a personal computer, video game system (e.g., PlayStation, Nintendo Gameboy, X-Box, etc.), workstation, server, minicomputer, mainframe, supercomputer, computer terminal, laptop, wearable computer, and/or Personal Digital Assistant (PDA), iPod, mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, a digital signal processor, an ASIC or other integrated circuit, a hardware electronic logic circuit such as a discrete element circuit, and/or a programmable logic device such as a PLD, PLA, FPGA, or PAL, or the like, etc.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
instructions—directions adapted to perform a particular operation or function. Can be implemented as firmware and/or software.
item—a single article of a plurality of articles.
link—a physical and/or logical communication channel between a pair of switching and/or routing devices; and/or an activateable connection to another web page, location in a web page, file, and/or other Internet resource.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine readable medium—a physical structure from which a machine can obtain data and/or information. Examples include a memory, punch cards, etc.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
network interface—any device, system, or subsystem capable of coupling an information device to a network. For example, a network interface can be a telephone, cellular phone, cellular modem, telephone data modem, fax modem, wireless transceiver, ethernet card, cable modem, digital subscriber line interface, bridge, hub, router, or other similar device.
packet—a discrete instance of communication.
plurality—the state of being plural and/or more than one.
precede—to occur and/or be located before.
predetermined—established in advance.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
product—something produced by human or mechanical effort or by a natural process.
provide—to furnish, supply, give, convey, send, and/or make available.
receive—to gather, take, acquire, obtain, accept, get, and/or have bestowed upon.
regarding—pertaining to.
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, tactile feedback mechanism, vibrator, etc.
repeatedly—again and again; repetitively.
request—(v.) to express a need and/or desire for; to inquire and/or ask for. (n.) that which communicates an expression of desire and/or that which is asked for.
running—in operation.
said—when used in a system or device claim, an article indicating a subsequent claim term that has been previously introduced.
selection—a choice and/or a result of choosing and/or selecting and/or an assortment of things from which a choice can be made.
sending—to convey.
server—an information device and/or a process running thereon that is adapted to be communicatively coupled to a network and that is adapted to provide at least one service for at least one other information device communicatively coupled to the network and/or for at least one process running on the other information device. A common example is a file server, which has a local disk and services requests from remote clients to read and write files on that disk. A server can also provide access to resources, such as programs, shared devices, etc.
session—an active communication between devices and/or applications over a network.
set—a related plurality.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asychronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
software—instructions executable on a machine and/or processor to create a specific physical configuration of digital gates and machine subsystems for processing signals.
store—to place, hold, and/or retain data, typically in a memory.
substantially—to a great extent or degree.
system—a collection of mechanisms, devices, machines, articles of manufacture, processes, data, and/or instructions, the collection designed to perform one or more specific functions.
user—a person, organization, process, device, program, protocol, and/or system that uses a device, system, process, and/or service.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
user-selected—that which is stated, provided, chosen, and/or determined by a user.
via—by way of and/or utilizing.
wherein—in regard to which; and; and/or in addition to.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive.

What is claimed is:

1. A method comprising:
from a server, sending product selection software to a first information device and to a second information device, said product selection software adapted to cause display of information regarding user-selected items;
via said server, creating a communication session linking said first information device to said second information device;
at said server, from said product selection software running on said first information device, receiving an identifier of a selected item; and
from said server, providing said identifier to said product selection software running on said second information device, receipt of said identifier by said product selection software running on said second information device adapted to cause information associated with said selected item to be rendered via said second information device.

2. The method of claim 1, further comprising:
receiving a request from said first information device to provide said product selection software from said server to said first information device and to said second information device.

3. The method of claim 1, wherein:
said receiving said identifier of said selected item is preceded by a selection, via said first information device, of said selected item.

4. The method of claim 1, wherein:
said information associated with said selected item is displayed via said second information device.

5. A machine-readable medium comprising machine instructions for activities comprising:
from a server, sending product selection software to a first information device and to a second information device, said product selection software adapted to cause display of information regarding user-selected items;
via said server, creating a communication session linking said first information device to said second information device;
at said server, from said product selection software running on said first information device, receiving an identifier of a selected item; and
from said server, providing said identifier to said product selection software running on said second information device, receipt of said identifier by said product selection software running on said second information device adapted to cause information associated with said selected item to be rendered via said second information device.
